(19) United States
(12) Patent Application Publication
(10) Pub. No.: US 2005/0158038 A1
(43) Pub. Date: Jul. 21, 2005

(54) Lowering the quality level of a selected program

(75) Inventors: Richard Dean Dettinger, Rochester, MN (US); Frederick Allyn Kulack, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/760,447

(22) Filed: Jan. 20, 2004

(51) Int. Cl. H04N 5/76; G02B 6/44

(52) U.S. Cl. 386/109; 385/112

(57) ABSTRACT

A method, apparatus, system, and signal-bearing medium that in an embodiment select a program based on a criteria if a storage threshold is exceeded and change the compression level of the selected program. Changing the compression level reduces the amount of storage consumed by the program. In various embodiments, the criteria may be based on a ranking of a category to which the program belongs, based on whether the program previously had the compression level changed, based on the age of the program, based on the difference between the current compression level of the program and the minimum compression level of the program, and/or the amount of storage space saved by changing the compression level of the program. In this way, storage may be made available for saving future programs without necessarily deleting current programs.

### FIELD

An embodiment of the invention generally relates to digital video recorders. In particular, an embodiment of the invention generally relates to managing the storage space used by programs in a digital video recorder.

### BACKGROUND

Television is certainly one of the most influential forces of our time. Through the device called a television set or TV, viewers are able to receive news, sports, entertainment, information, and commercials. A few events stand out as extremely important in the history of television. The invention of the black-and-white TV set and the first broadcasts of television signals in 1939 and 1940 initiated the television age. This was followed by color television and its huge popularity starting in the 1950s. Cable and satellite television began competing with broadcast networks in the 1970s. In this same list must go the development and popularization of the VCR (video cassette recorder) starting in the 1970s and 1980s.

The VCR marks one of the most important events in the history of television because, for the first time, the VCR gave the viewers control of what they could watch on their TV sets and at what time. The VCR spawned the video rental and sales market, and today, VCRs are commonplace.

Now, a new innovation makes recording television programs even more convenient: the digital video recorder, or DVR. The television signal comes into the digital video recorder's built-in tuner through antenna, cable, or satellite. If the signal comes from an analog antenna or cable, it goes into an encoder, which converts the data from analog to digital form. From the encoder, the signal is sent to two different places: first, to an internal hard drive for storage, and second, to a decoder, which converts the signal back to analog and sends it to the television for viewing. For a satellite signal and for cable and antenna signals that are already digital, the encoder is not necessary.

Although the digital video recorder performs much the same functions as a VCR, there are some important differences. First, a digital video recorder is tape-less and has no removable media. With a VCR, the device itself is merely a recording tool; the blank cassette is the removable media. In a digital video recorder, the media and tool are one and the same. This is an advantage because buying and cataloging tapes are unnecessary, but it can also be a disadvantage: since the media is hard-wired internal to the digital video recorder, adding additional storage space is not possible. Obtaining more recording time is easy with a VCR because the user need only buy another box of blank tapes, which are inexpensive and readily available. In contrast, obtaining additional recording time on a digital video recorder involves buying an entire new machine.

Because recording time on the digital video recorder's internal hard drive is limited, digital video recorders typically cycle through the recorded programs, looking for programs to delete in order to free up space for new recordings. Digital video recorders typically have priority-based rules for selecting which programs to delete. For example, programs that the digital video recorder records automatically based on viewing habits of the user may be deleted first, followed by programs that the user has given low priority. Although deleting programs has the advantage that space is made available for new recordings, it has a significant disadvantage: programs are deleted that the user may want to view.

Without a better way for managing the storage space used by programs, viewers will not be able to take full advantage of a digital video recorder. Although the aforementioned problems have been described in the context of a digital video recorder, they may apply to any electronic device that stores data in a limited storage space.

### SUMMARY

A method, apparatus, system, and signal-bearing medium are provided that in an embodiment select a program based on a criteria if a storage threshold is exceeded and change the compression level of the selected program. Changing the compression level reduces the amount of storage consumed by the program. In various embodiments, the criteria may be based on a ranking of a category to which the program belongs, based on whether the program previously had the compression level changed, based on the age of the program, based on the difference between the current compression level of the program and the minimum compression level of the program, and/or the amount of storage space saved by changing the compression level of the program. In this way, storage may be made available for saving future programs without necessarily deleting current programs.

### BRIEF DESCRIPTION OF THE DRAWING

FIG. 1 depicts a block diagram of an example digital video recorder for implementing an embodiment of the invention.

FIG. 2 depicts a block diagram of an example computer system for implementing an embodiment of the invention.

FIG. 3 depicts a block diagram of an example categories data structure, according to an embodiment of the invention.

FIG. 4 depicts a block diagram of an example data structure for profile data, according to an embodiment of the invention.

FIG. 5 depicts a block diagram of an example data structure for aging criteria, according to an embodiment of the invention.

FIG. 6 depicts a flowchart of example processing in a controller for lowering the quality of a program, according to an embodiment of the invention.

FIG. 7 depicts a flowchart of example processing in a controller for a selecting a program, according to an embodiment of the invention.

### DETAILED DESCRIPTION

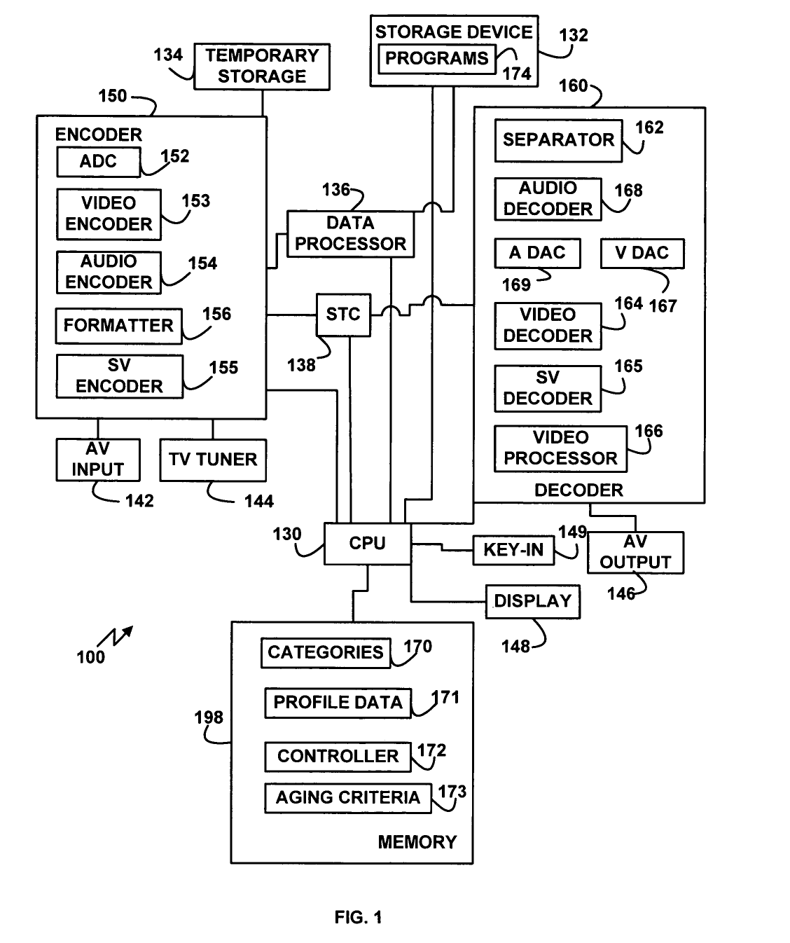

Referring to the Drawing, wherein like numbers denote like parts throughout the several views, FIG. 1 depicts a block diagram of an example digital video recorder 100 used for recording/playing back digital moving image information, according to an embodiment of the invention. The digital video recorder 100 includes a CPU (central processing unit) 130, a storage device 132, temporary storage 134, a data processor 136, a system time counter 138, an audio/video input 142, a TV tuner 144, an audio/video output 146, a display 148, a key-in 149, an encoder 150, a decoder 160, and memory 198.

The CPU 130 may be implemented via a programmable general purpose central processing unit that controls operation of the digital video recorder 100.

The storage device 132 may be implemented by a direct access storage device (DASD), a DVD-RAM, a CD-RW, or any other type of storage device capable of reading and writing data. The storage device 132 stores the programs 174. The programs 174 are data that is capable of being compressed to different levels of compression, where the different levels of compression have different quality levels. That is, compressing the data causes a degradation in quality of the data or a partial loss of the data that cannot be recovered. In various embodiments, the programs 174 may be television programs, movies, video, audio, still images or graphics, or any combination thereof.

One example of moving between different compression levels for moving images having different quality levels is moving between high-quality MPEG-2 (Moving Picture Experts Group) video, moderately compressed MPEG-2 video, and highly compressed MPEG-1 video. An example one-hour TV program saved in high-quality MPEG-2 will have excellent visual quality and will consume 3.4 gigabytes in the storage device 132. The same one-hour TV program saved in moderately compressed MPEG-2 video will have good visual quality and will consume about 1.7 gigabytes in the storage device 132. The same one-hour TV program saved in highly compressed MPEG-1 video will have a low visual-quality image that is noticeably grainy and will consume about 0.6 gigabytes in the storage device 132.

One example of moving between different compression levels for still images having different quality levels is moving between the formats of BMP, GIF, and different levels of JPEG. But, in other embodiments any appropriate formats may be used.

BMP is an acronym for Basic Multilingual Plane or otherwise known as a Bitmap. BMP is a bitmap format as the name implies. It has no compression rate and is a “loss less” format in that no information is lost in the conversion process.

GIF is an acronym for Graphics Interchange Format. It is a “raster image format” in that it is a bitmap image made up of a series of predefined pixels. GIF is a “lossy” file format in that it reduces an image's file size by removing bits of color information during the conversion process, which lowers the quality.

JPEG is an acronym for Joint Photographic Experts Group. This is the original name of the committee that designed the standard image compression algorithm. JPEG is a “raster image format” in that it is a bitmap image made up of a series of predefined pixels. It has a range of compression options, from minimum compression/high image quality to maximum compression/lower image quality. JPEG uses a lossy compression technique, which changes the original image by removing color information during the conversion process. This means that the higher the compression rate, the bigger the loss of information in the file itself and the resultant lowering of quality.

The encoder section 150 includes an analog-digital converter 152, a video encoder 153, an audio encoder 154, a sub-video encoder 155, and a formatter 0.156.

The analog-digital converter 152 is supplied with an external analog video signal and an external analog audio signal from the audio-video input 142 or an analog TV signal and an analog voice signal from the TV tuner 144. The audio-video converter 152 converts an input analog video signal into a digital form. That is, the audio-video converter 152 quantitizes into digital form a luminance component Y, color difference component Cr (or Y-R), and color difference component Cb (or Y-B). Further, the analog-digital converter 152 converts an input analog audio signal into a digital form.

When an analog video signal and digital audio signal are input to the analog-digital converter 152, the analog-digital converter 152 passes the digital audio signal therethrough as it is. At this time, a process for reducing the jitter attached to the digital signal or a process for changing the sampling rate or quantization bit number may be effected without changing the contents of the digital audio signal. Further, when a digital video signal and digital audio signal are input to the analog-digital converter 152, the analog-digital converter 152 passes the digital video signal and digital audio signal therethrough as they are. The jitter reducing process or sampling rate changing process may be effected without changing the contents of the digital signals.

The digital video signal component from the analog-digital converter 152 is supplied to the formatter 156 via the video encoder 153. The digital audio signal component from the analog-digital converter 152 is supplied to the formatter 156 via the audio encoder 154.

The video encoder 153 converts the input digital video signal into a compressed digital signal at a variable bit rate. For example, the video encoder 153 may implement the MPEG2 or MPEG1 specification, but in other embodiments any appropriate specification may be used.

The audio encoder 154 converts the input digital audio signal into a digital signal (or digital signal of linear PCM (Pulse Code Modulation)) compressed at a fixed bit rate based, e.g., on the MPEG audio or AC-3 specification, but in other embodiments any appropriate specification may be used.

When a video signal is input from the audio-video input 142 or when the video signal is received from the TV tuner 144, the sub-video signal component in the video signal is input to the sub-video encoder 155. The sub-video data input to the sub-video encoder 155 is converted into a preset signal configuration and then supplied to the formatter 156. The formatter 156 performs preset signal processing for the input video signal, audio signal, sub-video signal and outputs record data to the data processor 136.

The temporary storage section 134 buffers a preset amount of data among data (data output from the encoder 150) written into the storage device 132 or buffers a preset amount of data among data (data input to the decoder section 160) played back from the storage device 132.

The data processor 136 supplies record data from the encoder section 150 to the storage device 132, extracts a playback signal played back from the storage device 132, rewrites management information recorded on the storage device 132, or deletes data recorded on the storage device 132 according to the control of the CPU 130.

The contents to be notified to the user of the digital video recorder 100 are displayed on the display 148 or are displayed on a TV or monitor (not shown) attached to the audio-video output 146.

The timings at which the CPU 130 controls the storage device 132, data processor 136, encoder 150, and/or decoder 160 are set based on time data from the system time counter 138. The recording/playback operation is normally effected in synchronism with the time clock from the system time counter 138, and other processes may be effected at a timing independent from the system time counter 138.

The decoder 160 includes a separator 162 for separating and extracting each pack from the playback data, a video decoder 164 for decoding main video data separated by the separator 162, a sub-video decoder 165 for decoding sub-video data separated by the separator 162, an audio decoder 168 for decoding audio data separated by the separator 162, and a video processor 166 for combining the sub-video data from the sub-video decoder 165 with the video data from the video decoder 164.

The video digital-analog converter 167 converts a digital video output from the video processor 166 to an analog video signal. The audio digital-analog converter 169 converts a digital audio output from the audio decoder 168 to an analog audio signal. The analog video signal from the video digital-analog converter 167 and the analog audio signal from the audio digital-analog converter 169 are supplied to external components (not shown), which are typically a television set, monitor, or projector, via the audio-video output 146.

Next, the recording process and playback process of the digital video recorder 100 are explained, according to an embodiment. At the time of data processing for recording, if the user first effects the key-in operation via the key-in 149, the CPU 130 receives a recording instruction for a program and reads out management data from the storage device 132 to determine an area in which video data is recorded. In another embodiment, the CPU 130 determines the program to be recorded.

Then, the CPU 130 sets the determined area in a management area and sets the recording start address of video data on the storage device 132. In this case, the management area specifies the file management section for managing the files, and control information and parameters necessary for the file management section are sequentially recorded.

Next, the CPU 130 resets the time of the system time counter 138. In this example, the system time counter 138 is a timer of the system and the recording/playback operation is effected with the time thereof used as a reference.

The flow of a video signal is as follows. An audio-video signal input from the audio-video input 142 or the TV tuner 144 is A/D converted by the analog-digital converter 152, and the video signal and audio signal are respectively supplied to the video encoder 153 and audio encoder 154, and the closed caption signal from the TV tuner 144 or the text signal of text broadcasting is supplied to the sub-video encoder 155.

The encoders 153, 154, 155 compress the respective input signals to make packets, and the packets are input to the formatter 156. In this case, the encoders 153, 154, 155 determine and record PTS (presentation time stamp), DTS (decode time stamp) of each packet according to the value of the system time counter 138. The formatter 156 sets each input packet data into packs, mixes the packs, and supplies the result of mixing to the data processor 136. The data processor 136 sends the pack data to the storage device 132, which stores it as one of the programs 174.

At the time of playback operation, the user first effects a key-in operation via the key-in 149, and the CPU 130 receives a playback instruction therefrom. Next, the CPU 130 supplies a read instruction and address of the program 174 to be played back to the storage device 132. The storage device 132 reads out sector data according to the supplied instruction and outputs the data in a pack data form to the decoder section 160.

In the decoder section 160, the separator 162 receives the readout pack data, forms the data into a packet form, transfers the video packet data (e.g., MPEG video data) to the video decoder 164, transfers the audio packet data to the audio decoder 168, and transfers the sub-video packet data to the sub-video decoder 165.

After this, the decoders 164, 165, 168 effect the playback processes in synchronism with the values of the PTS of the respective packet data items (output packet data decoded at the timing at which the values of the PTS and system time counter 138 coincide with each other) and supply a moving picture with voice caption to the TV, monitor, or projector (not shown) via the audio-video output 146.

The memory 198 is connected to the CPU 130 and includes the categories 170, the profile data 171, the controller 172, and the aging criteria 173.

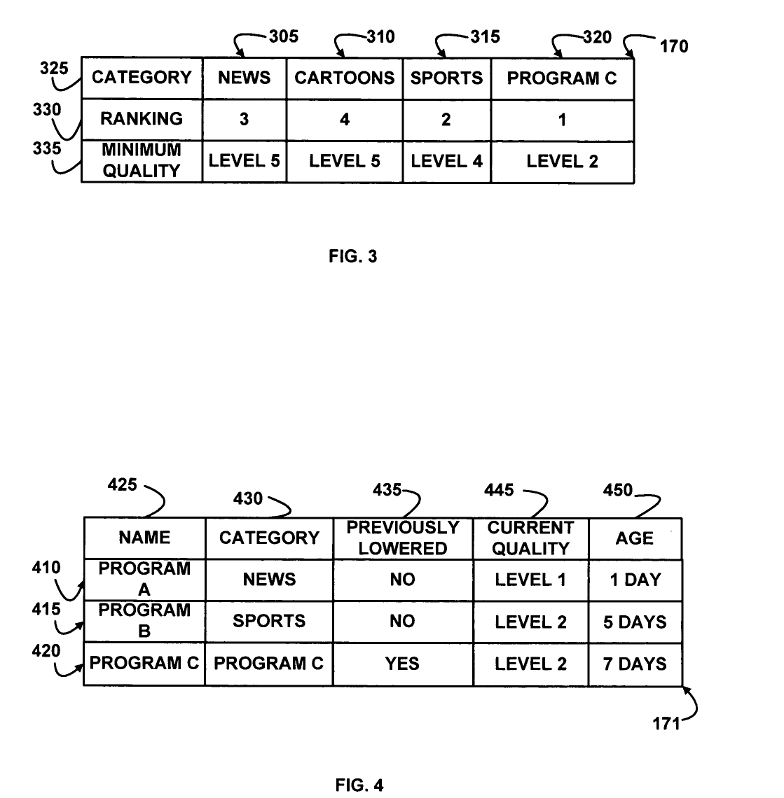

The categories 170 describe the categories or sets to which the programs 174 belong. The categories data structure 170 is further described below with reference to FIG. 3. The profile data 171 describes the programs 174. The profile data 171 is further described below with reference to FIG. 4.

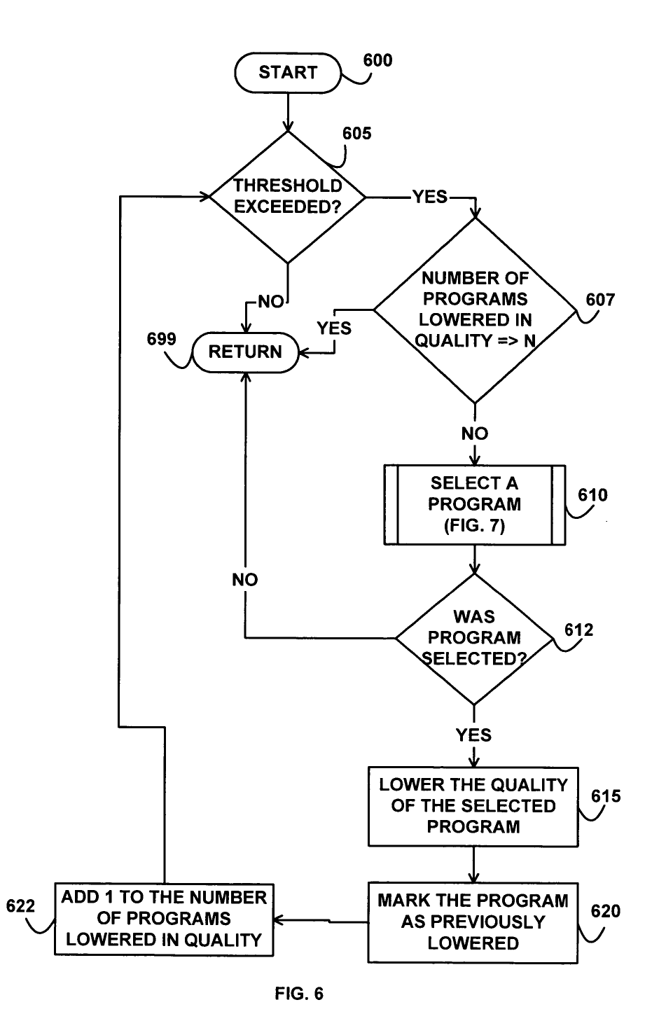

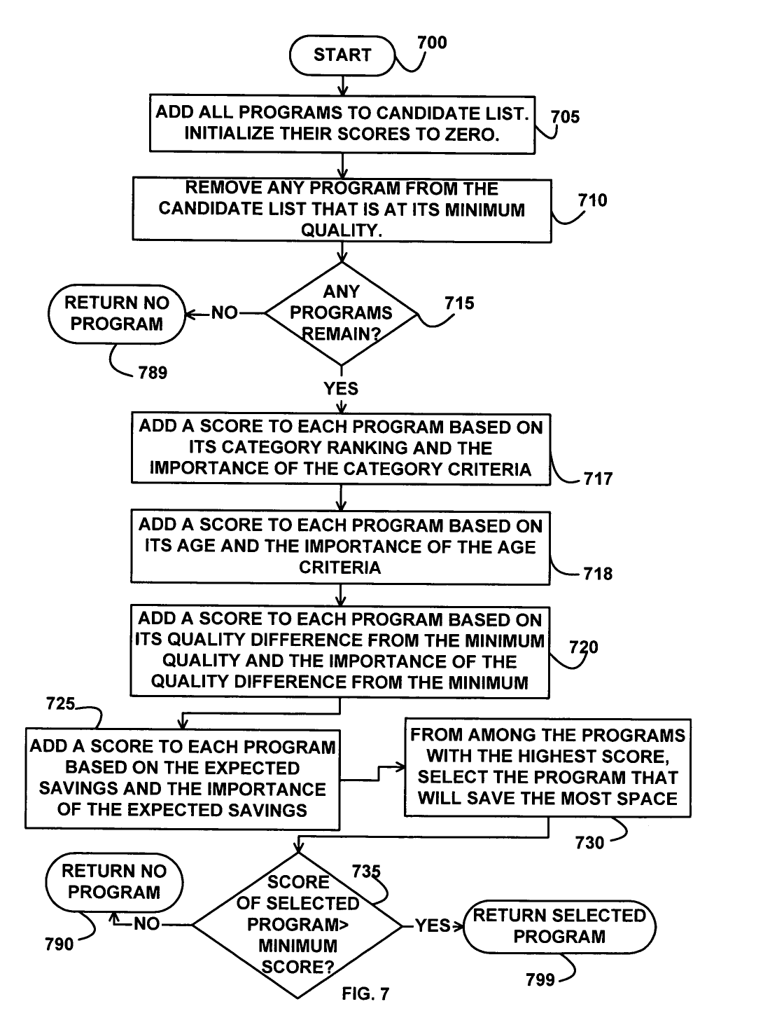

The controller 172 includes instructions capable of executing on the CPU 130 or statements capable of being interpreted by instructions executing on the CPU 130 to manipulate data structures, as further described below with reference to FIGS. 3, 4, and 5 and to perform the functions as further described below with reference to FIGS. 6 and 7. In another embodiment, the controller 172 may be implemented in microcode. In another embodiment, the controller 172 may be implemented in hardware via logic gates and/or other appropriate hardware techniques in lieu of or in addition to a processor-based digital video recorder.

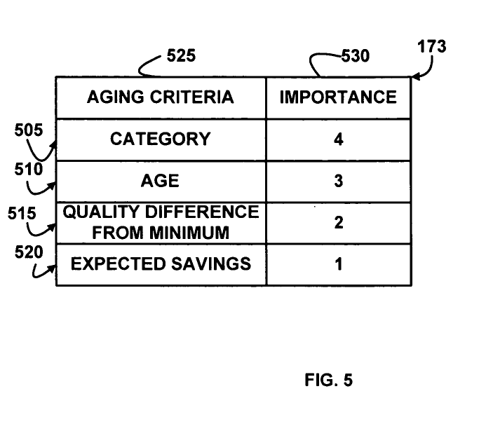

The aging criteria 173 includes data that the controller 172 uses to determine which of the programs 174 to lower in quality. The aging criteria 173 is further described below, with reference to FIG. 5.

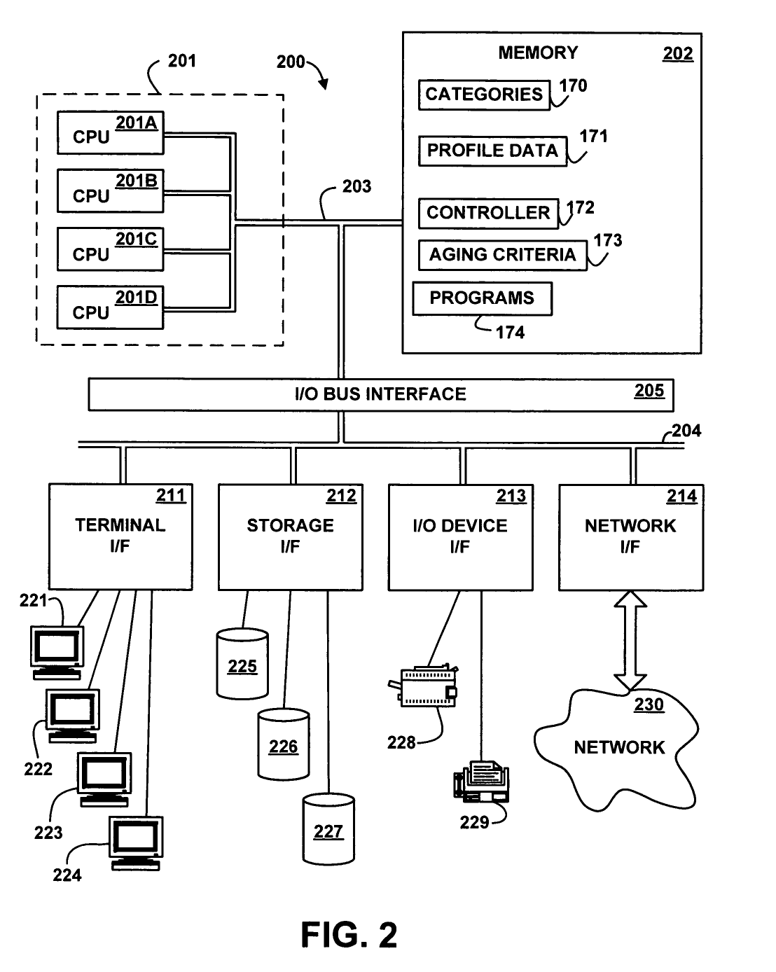

FIG. 2 depicts a high-level block diagram representation of a computer system 200, according to an embodiment of the present invention. The major components of the computer system 200 include one or more processors 201, a main memory 202, a terminal interface 211, a storage interface 212, an I/O (Input/Output) device interface 213, and communications/network interfaces 214, all of which are coupled for inter-component communication via a memory bus 203, an I/O bus 204, and an I/O bus interface unit 205.

The computer system 200 contains one or more general-purpose programmable central processing units (CPUs) 201A, 201B, 201C, and 201D, herein generically referred to as the processor 201. In an embodiment, the computer system 200 contains multiple processors typical of a relatively large system; however, in another embodiment the computer system 200 may alternatively be a single CPU system. Each processor 201 executes instructions stored in the main memory 202 and may include one or more levels of on-board cache.

The main memory 202 is a random-access semiconductor memory for storing data and computer programs. The main memory 202 is conceptually a single monolithic entity, but in other embodiments the main memory 202 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The memory 202 includes the categories 170, the profile data 171, the controller 172, the aging criteria 173, and the programs 174. Although the categories 170, the profile data 171, the controller 172, the aging criteria 173, and the programs 174 are illustrated as being contained within the memory 202 in the computer system 200, in other embodiments some or all may be on different computer systems and may be accessed remotely, e.g., via the network 230. The computer system 200 may use virtual addressing mechanisms that allow the software of the computer system 200 to behave as if it only has access to a large, single storage entity instead of access to multiple, smaller storage entities. Thus, while the categories 170, the profile data 171, the controller 172, the aging criteria 173, and the programs 174 are illustrated as residing in the memory 202, these elements are not necessarily all completely contained in the same storage device at the same time.

In an embodiment, the controller 172 includes instructions capable of executing on the processors 201 or statements capable of being interpreted by instructions executing on the processors 201 to manipulate the categories 170, the profile data 171, and the aging criteria 173, as further described below with reference to FIGS. 3, 4, and 5 and to perform the functions as further described below with reference to FIGS. 6 and 7. In another embodiment, the controller 172 may be implemented in microcode. In another embodiment, the controller 172 may be implemented in hardware via logic gates and/or other appropriate hardware techniques in lieu of or in addition to a processor-based system.

The aging criteria 173 includes data that the controller 172 uses to determine which of the programs 174 to lower in quality. The aging criteria 173 is further described below, with reference to FIG. 5.

The memory bus 203 provides a data communication path for transferring data among the processors 201, the main memory 202, and the I/O bus interface unit 205. The I/O bus interface unit 205 is further coupled to the system I/O bus 204 for transferring data to and from the various I/O units. The I/O bus interface unit 205 communicates with multiple I/O interface units 211, 212, 213, and 214, which are also known as I/O processors (IOPs) or I/O adapters (IOAs), through the system I/O bus 204. The system I/O bus 204 may be, e.g., an industry standard PCI (Peripheral Component Interconnect) bus, or any other appropriate bus technology. The I/O interface units support communication with a variety of storage and I/O devices. For example, the terminal interface unit 211 supports the attachment of one or more user terminals 221, 222, 223, and 224.

The storage interface unit 212 supports the attachment of one or more direct access storage devices (DASD) 225, 226, and 227 (which are typically rotating magnetic disk drive storage devices, although they could alternatively be other devices, including arrays of disk drives configured to appear as a single large storage device to a host). The I/O and other device interface 213 provides an interface to any of various other input/output devices or devices of other types. Two such devices, the printer 228 and the fax machine 229, are shown in the exemplary embodiment of FIG. 2, but in other embodiment many other such devices may exist, which may be of differing types. The network interface 214 provides one or more communications paths from the computer system 200 to other digital devices and computer systems; such paths may include, e.g., one or more networks 230.

The network 230 may be any suitable network or combination of networks and may support any appropriate protocol suitable for communication of data and/or code to/from the computer system 200. In an embodiment, the network 230 may represent a television network, whether cable, satellite, or broadcast TV, either analog or digital. In an embodiment, the network 230 may represent a storage device or a combination of storage devices, either connected directly or indirectly to the computer system 200. In an embodiment, the network 230 may support Infiniband. In another embodiment, the network 230 may support wireless communications. In another embodiment, the network 230 may support hard-wired communications, such as a telephone line or cable. In another embodiment, the network 230 may support the Ethernet IEEE (Institute of Electrical and Electronics Engineers) 802.3x specification. In another embodiment, the network 230 may be the Internet and may support IP (Internet Protocol). In another embodiment, the network 230 may be a local area network (LAN) or a wide area network (WAN). In another embodiment, the network 230 may be a hotspot service provider network. In another embodiment, the network 230 may be an intranet. In another embodiment, the network 230 may be a GPRS (General Packet Radio Service) network. In another embodiment, the network 230 may be a FRS (Family Radio Service) network. In another embodiment, the network 230 may be any appropriate cellular data network or cell-based radio network technology. In another embodiment, the network 230 may be an IEEE 802.11B wireless network. In still another embodiment, the network 230 may be any suitable network or combination of networks. Although one network 230 is shown, in other embodiments any number of networks (of the same or different types) may be present.

Although the memory bus 203 is shown in FIG. 1 as a relatively simple, single bus structure providing a direct communication path among the processors 201, the main memory 202, and the I/O bus interface 205, in another embodiment the memory bus 203 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 205 and the I/O bus 204 are shown as single respective units, in other embodiments the computer system 200 may contain multiple I/O bus interface units 205 and/or multiple I/O buses 204. While multiple I/O interface units are shown, which separate the system I/O bus 204 from various communications paths running to the various I/O devices, in other embodiments some or all of the I/O devices are connected directly to one or more system I/O buses.

The computer system 200 depicted in FIG. 2 has multiple attached terminals 221, 222, 223, and 224, such as might be typical of a multi-user “mainframe” computer system. Typically, in such a case the actual number of attached devices is greater than those shown in FIG. 2, although the present invention is not limited to systems of any particular size. The computer system 200 may alternatively be a single-user system, typically containing only a single user display and keyboard input, or might be a server or similar device that has little or no direct user interface, but receives requests from other computer systems (clients). In other embodiments, the computer system 200 may be implemented as a personal computer, portable computer, laptop or notebook computer, PDA (Personal Digital Assistant), tablet computer, pocket computer, telephone, pager, automobile, teleconferencing system, video recorder, MP3 (MPEG Audio Layer 3) player, appliance, or any other appropriate type of electronic device.

It should be understood that FIG. 2 is intended to depict the representative major components of the computer system 200 at a high level, that individual components may have greater complexity that represented in FIG. 2, that components other than, instead of, or in addition to those shown in FIG. 2 may be present, and that the number, type, and configuration of such components may vary. Several particular examples of such additional complexity or additional variations are disclosed herein; it being understood that these are by way of example only and are not necessarily the only such variations.

The various software components illustrated in FIG. 2 and implementing various embodiments of the invention may be implemented in a number of manners, including using various computer software applications, routines, components, programs, objects, modules, data structures, etc., referred to hereinafter as “computer programs.” The computer programs typically comprise one or more instructions that are resident at various times in various memory and storage devices in the computer system 200, and that, when read and executed by one or more processors 201 in the computer system 200, cause the computer system 200 to perform the steps necessary to execute steps or elements embodying the various aspects of an embodiment of the invention.

Moreover, while embodiments of the invention have and hereinafter will be described in the context of fully functioning computer systems and digital video recorders, the various embodiments of the invention are capable of being distributed as a program product in a variety of forms, and the invention applies equally regardless of the particular type of signal-bearing medium used to actually carry out the distribution. The programs defining the functions of this embodiment may be delivered to the digital video recorder 100 and/or the computer system 200 via a variety of signal-bearing media, which include, but are not limited to:
(1) information permanently stored on a non-rewriteable storage medium, e.g., a read-only memory device attached to or within a computer system, such as a CD-ROM readable by a CD-ROM drive;
(2) alterable information stored on a rewriteable storage medium, e.g., a hard disk drive (e.g., DASD 225, 226, or 227, the storage device 132, or the memory 198) or diskette; or
(3) information conveyed to the digital video recorder 100 or the computer system 200 by a communications medium, such as through a computer or a telephone network, e.g., the network 230, including wireless communications.

Such signal-bearing media, when carrying machine-readable instructions that direct the functions of the present invention, represent embodiments of the present invention.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIGS. 1 and 2 are not intended to limit the present invention. Indeed, other alternative hardware and/or software environments may be used without departing from the scope of the invention.

FIG. 3 depicts a block diagram of an example data structure for the categories 170, according to an embodiment of the invention. The controller 172 uses the categories 170, as further described below with reference to FIGS. 6 and 7. The categories data structure 170 includes example entries 305, 310, 315, and 320, but in other embodiments any number of entries with any appropriate data may be used. Each entry includes a category field 325, a ranking field 330, and a minimum quality field 315.

The category field 325 specifies categories or sets of the programs 174 into which the controller 172 may divide the programs 174. In various embodiments, the categories 325 may be specified by the user, supplied by the controller 172, or any combination thereof. In the example shown, the entry 305 includes a news category, the entry 310 includes a cartoons category, the entry 315 includes a sports category, and the entry 320 includes a program C category, which is a name of a program in the programs 174 and indicates that a category may include only a single program: in this example program C.

The ranking field 330 specifies the importance of the respective category 325. In an embodiment, the rankings 330 are relative values specifying the relative importance of the respective categories 325. In another embodiment, the rankings 330 may specify an initial quality level of the respective categories 325. The minimum quality field 335 specifies a minimum quality for the respective categories 325 below which the programs in the category 325 are not to drop.

FIG. 4 depicts a block diagram of an example data structure for the profile data 171, according to an embodiment of the invention. The profile data structure 171 includes example entries 410, 415, and 420, but in other embodiments any number of entries with any appropriate data may be used. Each entry includes a name field 425, a category field 430, and a previously-lowered field 435, a current quality field 445, and an age field 450.

The name field 425 specifies an identification (e.g., a name, address, or other identifying information) of a program in the programs 174. In an embodiment, every program in the programs 174 has an entry in the profile data 171. In another embodiment, only programs in the programs 174 that are subject to compression and/or lowering of quality have an entry in the programs 174. In the example data shown, the name field 425 includes program A in the entry 410, program B in the entry 415, and program C in the entry 420.

The category field 430 specifies a category to which the program identified by the respective name 425 belongs. In the example data shown, the category field 430 includes news in the entry 410, sports in the entry 415, and program C in the entry 420. The previously-lowered field 435 specifies whether the quality of the program identified by the respective name 425 has been previously lowered. The current quality field 445 specifies the current quality level of the program identified by the respective name 425. The age field 450 specifies the age of the program identified by the respective name 425 or the elapsed time since the program identified by the respective name 425 was originally recorded, stored, or created.

FIG. 5 depicts an example data structure for the aging criteria 173, according to an embodiment of the invention. The example aging criteria 173 includes entries 505, 510, 515, and 520, although in other embodiments any number of entries may be present. Each entry includes an aging criteria 525 and an importance field 530. The aging criteria field 525 includes the criteria that the controller 172 uses to age the programs 174. In the example shown, the entry 505 includes category in the aging criteria field 525, the entry 510 includes age in the aging criteria field 525, the entry 515 includes quality difference from minimum in the aging criteria field, and the entry 520 includes expected savings in the aging criteria field 525, although in other embodiments any appropriate data may be present. The importance field 530 includes the respective importance of the aging criteria 525. For example, the entry 505 includes an importance of 4, the entry 510 includes an importance of 3, the entry 515 includes an importance of 2, and the entry 520 includes an importance of 1.

FIG. 6 depicts a flowchart of example processing for the controller 172, according to an embodiment of the invention. Control begins at block 600. Control then continues to block 605 where the controller 172 determines whether the size of the programs 174 exceeds a threshold. In various embodiments, the threshold may be a fixed or variable threshold and may be expressed as an absolute value or as a percentage of the storage available for the programs 174. If the determination at block 605 is true, then the threshold has been exceeded, so control continues to block 607, where the controller 172 determines whether the number of programs that have been lowered in quality is greater than or equal to “N” where “N” is a configured setting that restricts the number of programs lowered in quality during a single sweep of the algorithm of FIG. 6. In an embodiment, N is selected to prevent all programs from simply being lowered to the lowest quality when the storage threshold is reached. If the determination at block 607 is true, then control continues to block 699 where the logic of FIG. 6 returns.

If the determination at block 607 is false, then control continues to block 610 where the controller 172 selects a program in the programs 174, as further described below with reference to FIG. 7.

Control then continues to block 612 where the controller 172 determines whether a program was previously selected at block 610. If a program was not previously selected at block 610, then control continues to block 699 where the logic of FIG. 6 returns. If a program was previously selected at block 610, then control continues from block 612 to block 615 where the controller 172 lowers the quality of the selected program in the programs 174. Lowering the quality of the selected program includes compressing the selected program so that its storage size is reduced.

Control then continues to block 620 where the controller 172 marks the selected program as previously lowered via the previously lowered field 435 in the profile data 171. Control then continues to block 622 where the controller 172 adds one to the number of programs lowered in quality. Control then returns to block 605, as previously described above.

If the determination at block 605 is false, then the threshold is not exceeded, so control continues to block 699 where the logic of FIG. 6 returns.

FIG. 7 depicts a flowchart of example processing for a selecting a program in the programs 174 by the controller 172, according to an embodiment of the invention. Control begins at block 700. Control then continues to block 705 where the controller 172 adds all of programs from the programs 174 to a candidate list. The controller 172 then initializes all scores for the programs in the candidate list to zero. Control then continues to block 710 where the controller 172 removes any program from the candidate list that is at its minimum quality 335. In an embodiment, the controller 172 also removes all programs from the candidate list that were previously lowered, which the controller 172 determines via the previously-lowered field 435.

Control then continues to block 715 where the controller 172 determines whether any programs remain in the candidate list. If the determination at block 715 is false, then control continues to block 789 where the controller 172 returns that no program has been selected.

If the determination at block 715 is true, then at least one program remains in the candidate list, so control continues to block 717 where the controller 172 adds a score to each program in the candidate list based on its category ranking 330 and the importance 530 of the category criteria 305. In an embodiment, the controller 172 determines the score by dividing the importance 530 of the category criteria 505 by the category ranking 330. Using the example data shown in FIGS. 3, 4, and 5, ranking 1 gets a score of 4/1=4, ranking 2 gets a score of 4/2=2, ranking 3 gets a score of 4/3=1.33, and ranking 4 gets a score of 4/4=1. In this way, more importantly-ranked categories get lower scores, and less importantly-ranked categories get higher scores. Thus, program A (having a ranking of 3) gets a score of 1.33, and program B (having ranking of 2) gets a score of 2.

Control then continues to block 718 where the controller 172 adds a score to each program in the candidate list based on its age 450 and the importance 530 of the age criteria 510. In an embodiment, the controller 172 determines the score by dividing the age 450 by the importance 530 of the age criteria 510. Using the example data shown in FIGS. 3, 4, and 5, program A (having an age of 1 day) gets a score of 1/3=0.3, and program B (having an age of 5 days) gets a score of 5/3=1.6.

Control then continues to block 720 where the controller 172 adds a score to each program in the candidate list based on its quality difference from the minimum quality 335 and the importance 530 of the quality difference from the minimum 515. In an embodiment, the controller 172 determines the score by dividing the quality difference by the importance 530 of the quality difference criteria 515. Using the example data shown in FIGS. 3, 4, and 5, program A (having 4 levels of quality difference from its minimum) gets a score of 4/2=2, and program B (having 2 levels of quality difference from its minimum) gets a score of 2/2=1.

Control then continues to block 725 where the controller 172 adds a score to each program in the candidate list based on the expected storage savings of aging the respective program and the importance 530 of the expected savings 320. In an embodiment, the controller 172 determines the score by dividing the expected savings by the importance 530 of the expected savings criteria 520. Using the example data shown in FIGS. 3, 4, and 5, program A (assuming that compressing from level 1 to level 2 saves 1 gigabyte of storage) gets a score of 1/1=1, and program B (assuming that compressing from level 2 to level 3 saves 0.6 gigabytes of storage) gets a score of 0.6/1=0.6.

Control then continues to block 730 where the controller 172 selects from the programs in the candidate list with the highest score, the program that will save the most storage space. Based on the previously described example scores, program A has a score of 1.33+0.3+2+1=4.63 and program B has a score of 2+1.6+1+0.6=5.2, so program B has the highest score of the programs not previously lowered.

Control then continues to block 735 where the controller 172 determines whether the score of the selected program is greater than a minimum score. If the determination at block 735 is false, then control continues to block 790 where the controller 172 returns that no program is selected.

If the determination at block 735 is true, then the score of the selected program is greater than the minimum score, so control continues to block 799 where the controller 172 returns the selected program.

Although the logic of FIG. 7 illustrates a variety of criteria for selecting a program from the programs 174, in other embodiments only a subset of the criteria may be used.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

1. A method comprising:
if a threshold is exceeded, selecting a program based on a criteria; and
changing a compression level of the program, wherein the changing further reduces an amount of storage consumed by the program and causes an unrecoverable loss of data.

2. The method of claim 1, wherein the selecting further comprises:
selecting the program based on a ranking of a category to which the program belongs.

3. The method of claim 1, wherein the selecting further comprises:
selecting the program based on whether the program previously had the compression level changed.

4. The method of claim 1, wherein the selecting further comprises:
selecting the program based on an age of the program.

5. The method of claim 1, wherein the selecting further comprises:
selecting the program based on a difference between a current compression level of the program and a minimum compression level of the program.

6. The method of claim 1, wherein the selecting further comprises:
selecting the program based on the criteria and an importance of the criteria.

7. An apparatus comprising:
means for selecting a first program from a plurality of programs based on a ranking of a category to which the first program belongs if a threshold is exceeded; and
means for changing a compression level of the first program, wherein the changing further reduces an amount of storage consumed by the first program and causes an unrecoverable loss of data.

8. The apparatus of claim 7, wherein the means for selecting further comprises:
means for selecting the first program based on whether the first program previously had the compression level changed.

9. The apparatus of claim 7, wherein the means for selecting further comprises:
means for selecting the first program based on an age of the first program.

10. The apparatus of claim 7, wherein the means for selecting further comprises:
means for selecting the first program based on a difference between a current compression level of the first program and a minimum compression level of the first program.

11. The apparatus of claim 7, wherein the means for selecting further comprises:
means for selecting the first program from the plurality of programs wherein the changing the compression level of the first program saves a largest amount of space in the storage among the plurality of programs.

12. A signal-bearing medium encoded with instructions, wherein the instructions when executed comprise:
if a threshold is exceeded, selecting a first program from a plurality of programs based on a ranking of a category to which the first program belongs and based on whether the first program previously had a compression level changed; and
changing the compression level of the first program, wherein the changing further reduces an amount of storage consumed by the first program and causes an unrecoverable loss of data.

13. The signal-bearing medium of claim 12, wherein the selecting further comprises:
selecting the first program based on an age of the first program.

14. The signal-bearing medium of claim 12, wherein the selecting further comprises:
selecting the first program based on a difference between a current compression level of the first program and a minimum compression level of the first program.

15. The signal-bearing medium of claim 12, wherein the selecting further comprises:
selecting the first program from the plurality of programs wherein the changing the compression level of the first program saves a largest amount of space among the plurality of programs.

16. The signal-bearing medium of claim 12, wherein the ranking comprises an initial compression level of the first program.

17. A digital video recorder comprising:
a processor; and
a memory encoded with instructions, wherein the instructions when executed on the processor comprise:
if a threshold is exceeded, selecting a first program from a plurality of programs based on a ranking of a category to which the first program belongs, based on whether the first program previously had a compression level changed, and based on an age of the first program, and
changing the compression level of the first program, wherein the changing further reduces an amount of storage consumed by the first program and causes an unrecoverable loss of data.

18. The digital video recorder of claim 17, wherein the selecting further comprises:
selecting the first program based on a difference between a current compression level of the first program and a minimum compression level of the first program.

19. The digital video recorder of claim 17, wherein the selecting further comprises:
selecting the first program from the plurality of programs wherein the changing the compression level of the first program saves a largest amount of space among the plurality of programs.

20. The digital video recorder of claim 17, wherein the ranking comprises an initial compression level of the first program.

21. The digital video recorder of claim 17, wherein the instructions further comprise:
marking the first program as having the compression level previously changed.

22. A computer system comprising:
a processor; and
a memory encoded with instructions, wherein the instructions when executed on the processor comprise:
if a threshold is exceeded, selecting a first program from a plurality of programs based on a ranking of a category to which the first program belongs, based on whether the first program previously had a compression level changed, based on an age of the first program, and based on a difference between a current compression level of the first program and a minimum compression level of the first program, and
changing the compression level of the first program, wherein the changing further reduces an amount of storage consumed by the first program and causes an unrecoverable loss of data.

23. The computer system of claim 22, wherein the selecting further comprises:
selecting the first program from the plurality of programs wherein the changing the compression level of the first program saves a largest amount of space among the plurality of programs.

24. The computer system of claim 22, wherein the ranking comprises an initial compression level of the first program.

25. The computer system of claim 22, wherein the instructions further comprise:
marking the first program as having the compression level previously changed.
